(19) United States
(12) Patent Application Publication
(10) Pub. No.: US 2003/0040942 A1
(43) Pub. Date: Feb. 27, 2003

(54) System and method for insuring personal computers against damage caused by computer viruses

(76) Inventor: Joseph E. Hooten, McKinney, TX (US)

Correspondence Address: Michael L. Diaz, Michael L. Diaz, P.C., 555 Republic Drive, Suite 200, Plano, TX, 75074, US

(21) Appl. No.: 09/938,134

(22) Filed: Aug. 23, 2001

(51) Int. Cl. G06F 17/60

(52) U.S. Cl. 705/4

(57) ABSTRACT

A method and system for insuring a computer against damage caused by a computer virus. The system includes a computer and an insurer to provide coverage to a customer owning the computer in the event that a computer virus damages the computer. The coverage may include awarding a monetary fee to the customer for the damage, repairing the damaged computer, or replacing the damaged software or computer components. In addition, the insurer may require the fulfillment of several prerequisites in order to compensate the customer for computer virus damage.

### BACKGROUND OF THE INVENTION

1. Technical Field of the Invention

This invention relates to insurance systems and methodologies and, more particularly, to a system and method for insuring personal computers against damage caused by computer viruses.

2. Description of Related Art

With the advent and increased usage of computers, the transfer of information via the Internet and other electronic communication devices is well established. In fact, with the advancement of computers in capabilities has also come a corresponding increase in communication between the computing systems. Unfortunately, whether intentional or inadvertently, computer viruses have also increased. These computer viruses have caused considerable damage to both the computers and their installed software and data. One need only view the news reports to see the continual bombardment of computer viruses which businesses and individual computer users are confronted with each day.

To combat the threat of computer viruses to computers, anti-virus software programs have been developed which acts as shields against the destruction and degradation of information and software stored in the computer. These programs prevent many viruses from destroying computer software and its associated data. However, the anti-virus computer programs do not prevent all viruses from invading the computer systems. Various viruses have been developed to circumvent these existing anti-virus programs. Anti-virus program vendors continually provide updates to customers to combat the newly created viruses. Unfortunately, many times these vendors cannot develop “patches” fast enough to protect against newly developed computer viruses. Additionally, not all computer users are diligent in updating their anti-virus software programs. Therefore, anti-virus computer programs have not been completely successful in preventing the infection of viruses into computers.

There are existing insurance policies used to insure computer systems. However, existing insurance policies merely cover the physical loss or damage of the computer which is encountered during specific catastrophic events (e.g., fire, floods, power surges, theft, etc.). None of these insurance policies cover the infection of a computer by a computer virus or the protection of the computer's software and its associated stored data. Many computer owners desire some form of security in knowing that their computer is protected from the destructive effects of computer viruses.

Thus, it would be a distinct advantage to have a system and method which insures the computer against the invasion and subsequent destruction or degradation of the computer's software programs and data. It is an object of the present invention to provide such a system and method.

### SUMMARY OF THE INVENTION

In one aspect, the present invention is a system for insuring a customer having a computer against damage caused by a computer virus. The system includes a computer and an insurer providing insurance coverage against computer virus infection and damage to the computer. The insurer provides compensation to the customer if the computer becomes infected by a computer virus. The compensation may include a monetary fee to the customer, repairing installed software located in the computer, repairing damaged computer components, or replacing the software and computer components damaged by the computer virus.

In another embodiment, the present invention is a method of insuring a customer having a computer from damage caused by a computer virus. The method begins by an insurer offering coverage of a computer for damage caused by a computer virus to the customer. Next, the customer selects the coverage offered by the insurer. The method then moves to the step of the customer buying the offered coverage.

In still another aspect, the present invention is a method of insuring a customer having a computer from damage caused by a computer virus. The method begins by an insurer offering coverage of a computer for damage caused by a computer virus to the customer. Next, the customer selects coverage offered by the insurer. The customer then buys the offered coverage. The insurer then optionally requires the fulfillment of at least one prerequisite to be covered in the event of damage caused by a computer virus. A virus then infects the computer. The customer may then request compensation for damage caused by the computer virus. The insurer may then respond by providing compensation to the customer for the damage caused by the computer virus to the computer.

### BRIEF DESCRIPTION OF THE DRAWINGS

The invention will be better understood and its numerous objects and advantages will become more apparent to those skilled in the art by reference to the following drawings, in conjunction with the accompanying specification, in which:

FIG. 1 is a simplified block diagram illustrating the components of a system for insuring a specific personal computer against damage caused by a virus in the preferred embodiment of the present invention;

FIG. 2 is a flow chart outlining the steps for an insurer covering infection of a computer according to the teachings of the present invention;

FIG. 3 is a flow chart outlining the steps for an insurer covering infection of a computer in a first alternate embodiment of the present invention; and

FIG. 4 is a flow chart outlining the steps for an insurer covering infection of a computer in a second alternate embodiment of the present invention.

### DETAILED DESCRIPTION OF EMBODIMENTS

The present invention is a system and method for insuring computers against damage caused by computer viruses.

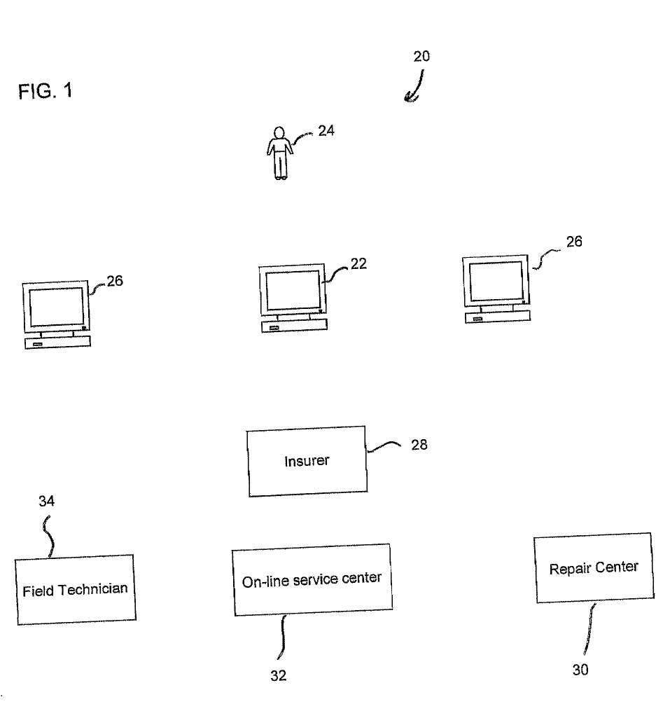

FIG. 1 is a simplified block diagram illustrating the components of a system 20 for insuring a specific personal computer 22 against a virus in the preferred embodiment of the present invention. The system includes the personal computer 22 operated or owned by a customer 24. The personal computer may be any individual computer or a computing system or device connected to a plurality of other computer systems 26. Within the system 20, an insurer 28 insures a specified computing system, in this example, computer 22. If a computer virus invades the computer 22, the customer may obtain repairs for the computer via a repair service center 30.

Alternatively, the customer may receive remote repairs via an online service center 32. Remote repair of computers is well established and understood by those skilled in the art of computer repair. In still another alternative, the customer may receive repairs to the computer 22 via a field technician 34 who travels to the location of the computer.

The customer 24 may enroll in an insurance program with the insurer 28. The insurance provided by the insurer may include a wide variety of options. In the preferred embodiment of the present invention, the insurer may provide coverage by providing repairs at both remote, on-line, or on-site locations. The customer may pay for the coverage by paying a periodic premium to the insurer. Alternatively, the customer may pay a flat fee to the insurer for coverage for a specified time.

The insurer may be a third party insurance company providing coverage on the computer 22 to the customer 24. Alternatively, the insurer may be an Internet service provider (ISP), manufacturer of the computer or a component of the computer, a retail store, or computer service center. It should be understood that the insurer may be any individual or company providing coverage for virus infection within the computer 22.

The coverage provided by the insurer 28 may also take various forms. The coverage may provide a specific monetary award for damages for the computer 22 caused by infection of a computer virus. The damage award may be based on the loss or damage of installed software or damage caused to the computer hardware. In an alternate embodiment of the present invention, the coverage may allow an infected computer to be repaired at the designated repair service center 30. The designated repair service center may be a stand alone center, a center incorporated with a retail store, or associated with some other service. In still another alternate embodiment, the computer repair may take place by an on-line service center 32 which remotely repairs the computer 22. This repair may take the form of reinstalling damaged or erased software or providing virus eradication software to remove the virus.

In an alternate embodiment of the present invention, the insurer may provide monetary awards based on loss of earnings or business coverage. With loss of earnings coverage, when a computer is infected with a virus which results in loss of earnings by the customer 24 during the time period that the computer 22 is down or the resulting loss of records, the insurer may compensate the customer accordingly. With such broad coverage, the premium paid by the customer is preferably raised to cover the additional liability for which the insurer must cover.

For the sake of reducing the liability the insurer may be faced to cover, a plurality of prerequisites may be required by the insurer from the customer to secure adequate protection against computer viruses. For example, the insurer 28 may optionally require the customer to install anti-virus software as well as periodically updating the software. At the time of servicing an infected computer, the insurer, repair service center 30, on-line service center 32 or field technician 34 may check to see if the prescribed prerequisites have been obeyed by the customer.

In addition, the insurer 28 may require the customer to provide a system software or hardware inventory (optionally requiring records) to the insurer to establish evidence of installed software or hardware.

In an alternate embodiment of the present invention, in order to reduce the liability associated by the insurer to the customer, compensation may be depreciated over a period of time. For example, if the insure covers replacing a computer or its software, after a period of time, the compensation is reduced to correspond to the actual value of the computer or software, which may be less than a completely new system or software. In such a case, the customer may be compensated at a fraction of the original value of the software or computer system/components.

The insurer 28 may market the insurance to the customer in a wide variety of ways. The insurer may provide pre-installed software within a newly purchased computer or software program, which can optionally provide a “pop-up” message upon initial or routine boot up of the purchased computer or through execution of a specified program. The insurer may also provide a coupon with purchased software or computer hardware, advertising to the customer that insurance is available for his computer 22 insuring against virus infection and the resulting damage. Additionally, a compact disc (CD) having insurance policy information may be provided via mail, the purchase of software, or the purchase of computer hardware.

The insurer may optionally provide coverage for a single individual customer having one computer or a customer having multiple standalone computers or networked computers.

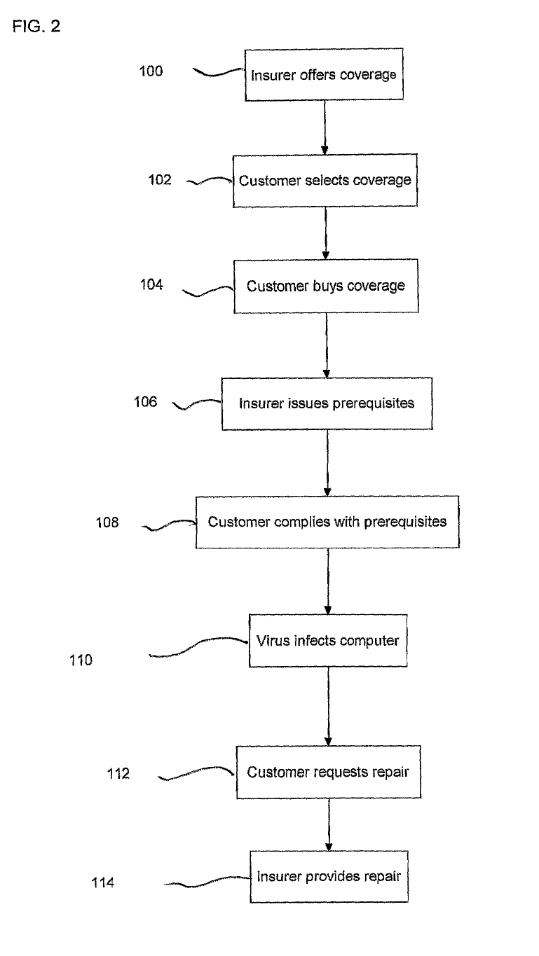

FIG. 2 is a flow chart outlining the steps for an insurer covering infection of a computer 22 by a computer virus according to the teachings of the present invention. With reference to FIGS. 1 and 2, the steps of the invention will now be explained. The method begins with step 100, where the insurer 28 offers insurance coverage covering damage done to computer software or hardware associated with the computer 22 to the customer 24 caused by a computer virus. The offering of insurance by the insurer may take different forms. In one embodiment, the insurer conventionally advertises one or more types of coverage for which the insurer will insure the computer. In an alternate embodiment, the insurer provides an offer with pre-installed software on newly purchased computers or software programs. A display may be provided upon boot up of the computer or the execution of a selected program. The insurer may provide an offer for coverage via the distribution of a CD providing various options of coverage. Additionally, the offer of coverage by the insurer may be provided via the Internet. The insurer may offer the coverage to a single individual customer having one computer, a customer having multiple standalone computers, or a customer utilizing a plurality of networked computers.

The specific type of coverage offered by the insurer to the customer may also take several different forms. In the preferred embodiment of the present invention, the insurer 28 may provide coverage for the repair or replacement of specified software or computer hardware. There may be a wide range of repair options and replacement options offered by the insurer to the customer.

In addition, in order to reduce the liability associated by the insurer to the customer, compensation may be depreciated over a period of time. For example, if the insure covers replacing a computer or its software, after a period of time, the compensation is reduced to correspond to the actual value of the computer or software, which may be less than a completely new system or software. In such a case, the customer may be compensated at a fraction of the original value of the software or computer system/components.

Next, in step 102, the customer optionally selects a coverage from a plurality of optional coverages offered by the insurer 28. The method then moves to step 104 where the customer buys the selected coverage from the insurer 28 by paying a premium to the insurer. The premium may be a periodic payment (e.g., monthly fee) or a flat fee for a longer period of time, such as $500 for a year's worth of coverage of the computer 22.

In step 106, the insurer may issue a plurality of prerequisites necessary for the customer to follow in order to maintain coverage by the insurer for the computer 22. The prerequisites may include installation of a selected anti-virus computer program with specified computer updates. Additionally, the insurer may require a list of installed software programs or detailed hardware installed within the computer. It must be understood that the insurer may issue any prerequisite to the customer to assure that the customer is taking all reasonable precautions to prevent infection of the computer by a virus. Additionally, the use of prerequisites may be used by the insurer to reduce the payout fees that the insurer must pay to the customer.

Next, the method moves to step 108 where the customer 24 follows the issued prerequisites in order for the computer 22 to be covered on the insurance policy of the insurer 28. In step 110, a virus infects the computer. The virus may cause damage to the computer's software or to one or more hardware components of the computer. Once the customer realizes that the computer is infected with a computer virus, the method moves to step 112 where the customer requests repair or replacement of selected software or selected computer hardware components.

Next, in step 114, the insurer 28 provides repair of the computer 22, selected installed software programs, or the replacement of selected software programs, depending on the coverage selected in step 102. In the situation where the insurer is providing coverage to the computer by promising repair of the computer, the insurer may fulfill the insurance coverage by providing a repair service center 30 for which the customer may deliver the infected computer for repairs. The repair service center may repair the infected computer using conventional repair methods to repair infected computers, such as reformatting the computer 22's hard drive, deleting infected software and reinstalling uninfected software programs, and physically repairing any hardware damage resulting from the computer virus. The repair service center may be at any location, such as with a retail store, another service, or an exclusive repair service center. In an alternate embodiment, the insurer may authorize the use of the field technician 34. The field technician goes on site at the location of the computer to provide repairs at the computer's location. In still another embodiment, the insurer may provide an on-line service center located remotely from the computer. The on-line service center may provide repairs via a communications link, such as the Internet. The repairs may include download of new software or remotely accessing the computer via the Internet to provide computer instructions to repair the computer.

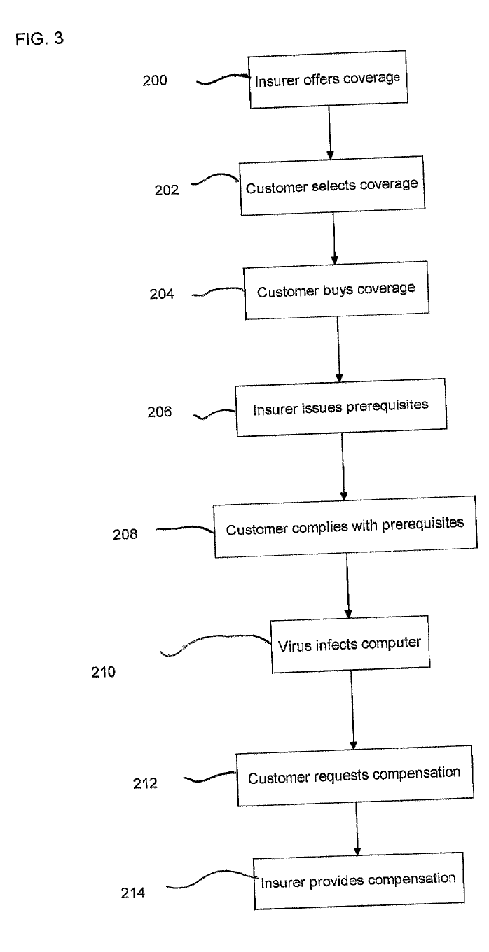

FIG. 3 is a flow chart outlining the steps for an insurer covering infection of a computer 22 against damage in a first alternate embodiment of the present invention. With reference to FIGS. 1 and 3, the steps of the invention will now be explained. In step 200, the insurer 28 offers insurance coverage covering damage done to computer software or hardware due to computer virus infection to the customer 24. The insurer may offer insurance to the customer in many different ways. In one embodiment, the insurer conventionally advertises one or more types of coverage for which the insurer will insure the computer against virus infection. In another embodiment, the insurer provides an offer with pre-installed software on newly purchased computers or software programs. A display may be provided upon boot up of the computer or the execution of a selected program. In still another embodiment, the insurer may provide an offer for coverage via the distribution of a CD providing various options of coverage. Additionally, the offer of coverage by the insurer may be provided via the Internet. The insurer may offer the coverage to a single individual customer having one computer, a customer having multiple standalone computers, or customer utilizing a plurality of networked computers. Any type of communication which allows the insurer to communicate his offer to the customer may be utilized.

The coverage provided in this first alternate embodiment may take different forms. The insurer 28 may provide monetary or replacement compensation for damage done by a computer virus to the computer 22. For example, if a virus invades the computer, the insurer may provide a flat fee of $500 to cover costs associated in purchasing new software to replace the infected software. In another example, the insurer may provide a specific amount to cover specific damage caused to the computer (e.g., a new computer valued at the replacement cost of the covered computer 22).

As discussed above, the insurer may only provide compensation based on a depreciated value of the computer or its software. As time goes by, the computer and its associated value is reduced in value. Rather than provide compensation based on replacing the computer or its software, a reduced award may be provided.

Next, in step 202, the customer optionally selects a coverage from a plurality of optional coverages offered by the insurer 28. The method then moves to step 204 where the customer buys the selected coverage from the insurer 28 by paying a premium to the insurer. The premium may be a periodic payment (e.g., monthly fee) or a flat fee for a longer period of time, such as $500 for a year's coverage of the computer 22.

In step 206, the insurer may issue a plurality of prerequisites necessary for the customer to follow in order to maintain coverage by the insurer for the computer 22. The prerequisites may include installation of a selected anti-virus computer program with specified computer updates. The insurer may also require a detailed inventory of software in order to maintain proper coverage by the insurer. It must be understood that the insurer may issue any prerequisite to the customer to assure that the customer is taking all reasonable precautions to prevent infection of the computer by a virus.

Next, in step 208, in order to secure coverage of the computer 22 by the customer 24, the customer follows the issued prerequisites. In step 210, a computer virus infects the computer. The virus may cause damage to the computer's software or to hardware components of the computer. Once the customer realizes that the computer is infected with a virus, the method moves to step 212 where the customer requests compensation for damage caused by a virus to the computer or its installed software.

Next, in step 214, the insurer 28 provides monetary compensation to the customer to replace the software or repair the computer 22. The compensation depends on the type of coverage selected by the customer in step 202. For example, the customer may be awarded a specified cash fee (e.g., five hundred dollars cash) for compensation of loss of software or cost to repair the damaged computer. In still another embodiment, the insurer may provide the customer with loss of business coverage which pays the loss of revenues during the down periods of the computer 22.

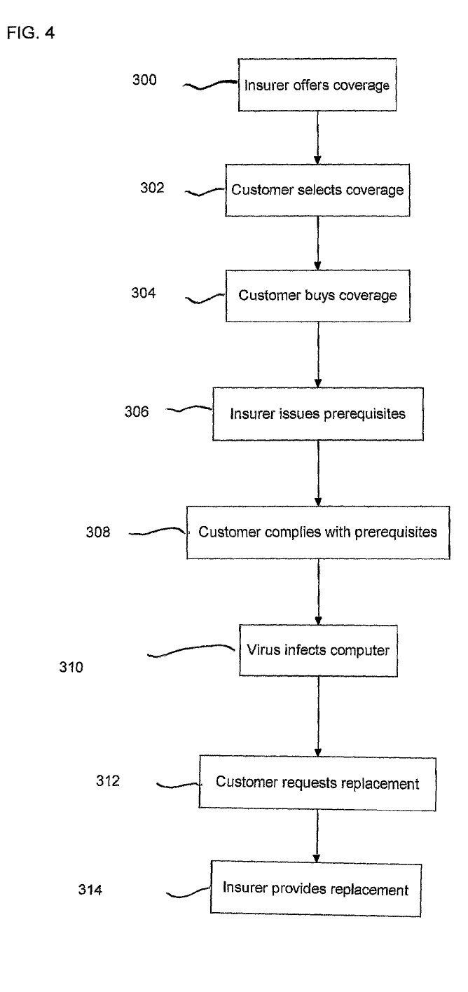

FIG. 4 is a flow chart outlining the steps for an insurer covering infection of a computer 22 in a second alternate embodiment of the present invention. With reference to FIGS. 1 and 4, the steps of the invention will now be explained. The method begins with step 300, where the insurer 28 offers insurance coverage covering damage done to computer software or hardware associated with the computer 22 to the customer 24. The offering of insurance by the insurer may take different forms. For example, the insurer may conventionally advertise one or more types of coverage for which the insurer will insure the computer. In another example, the insurer provides an offer with the purchase of pre-installed software on newly purchased computers or software programs. A display may be provided upon boot up of the computer or the execution of a selected program. The insurer may provide an offer for coverage via the distribution of a CD providing various options of coverage. Additionally, the offer of coverage by the insurer may be provided via the Internet. The insurer may offer the coverage to a single individual customer having one computer, a customer having multiple standalone computers, or customer utilizing a plurality of networked computers.

The type of coverage offered may vary also. In this second alternate embodiment of the present invention, the insurer 28 may provide coverage for the replacement of specified software or computer hardware. As stated above, the replacement of the software or computer hardware may be reduced, based on a calculated depreciated value of the damaged software or hardware.

Next, in step 302, the customer optionally selects a coverage from a plurality of optional coverages offered by the insurer 28. The method then moves to step 304 where the customer buys the selected coverage from the insurer 28 by paying a premium to the insurer. The premium may be a periodic payment (e.g., monthly fee) or a flat fee for a longer period of time, such as $500 for a year's coverage of the computer 22.

In step 306, the insurer may issue a plurality of prerequisites necessary for the customer to follow in order to maintain coverage by the insurer for the computer 22. The prerequisites may include installation of a selected anti-virus computer program with specified computer updates. Additionally, the insurer may require a list of installed software programs or detailed hardware installed within the computer. It must be understood that the insurer may issue any prerequisite (prior to acceptance by the customer of the offer) to the customer to assure that the customer is taking all reasonable precautions to prevent infection of the computer by a virus.

Next, the method moves to step 308 where the customer 24 follows the issued prerequisites in order for the computer 22 to be covered on the insurer's coverage. In step 310, a computer virus infects the computer. The virus may cause damage to the computer's software or to hardware components of the computer. Once the customer realizes that the computer is infected with a virus, the method moves to step 312 where the customer requests replacement of selected software or selected computer hardware components.

Next, in step 314, the insurer 28 provides replacement defined in the coverage to replace lost or damage software or hardware. The insurer may provide new programs to replace old software, or replacement of damaged computer components.

The system and method described herein provides many advantages. First, the system 20 uniquely provides for the repair or compensation to the computer owner of his computer when it is infected with a computer virus. All steps presently taken in the computer industry revolve around the prevention of viruses. However, with the creation of extremely sophisticated types of viruses, prevention is becoming a more difficult task. The disclosed invention provides for the eventuality of virus infection of the computer. Additionally, the disclosed invention, through the use of insurance prerequisites, encourages the customer to perform active preventative measures to avoid infection by a computer virus.

It is thus believed that the operation and construction of the present invention will be apparent from the foregoing description. While the method and system shown and described have been characterized as being preferred, it will be readily apparent that various changes and modifications could be made therein without departing from the scope of the invention as defined in the following claims.

What is claimed is:

1. A system for insuring a customer having a computer against damage caused by a computer virus, said system comprising:
a computer;
an insurer providing insurance coverage against computer virus infection of said computer; and
means for compensating the customer if said computer becomes infected with a computer virus;
wherein said insurer provides compensation to the customer when said computer becomes infected with the virus.

2. The system of claim 1 wherein said computer virus causes damages to at least one software program installed in said computer.

3. The system of claim 2 wherein said compensating means includes providing the customer with a monetary compensation to replace the installed software program.

4. The system of claim 2 wherein said compensating means includes replacing the installed software program with a comparable software program.

5. The system of claim 2 wherein said compensating means includes repairing the installed software program.

6. The system of claim 1 wherein said computer includes at least one computer component and the computer virus causes damage to at least one hardware component of said computer.

7. The system of claim 6 wherein said compensating means includes providing the customer with a monetary award to replace the damaged computer component.

8. The system of claim 6 wherein said compensating means includes replacing the damaged computer component.

9. The system of claim 6 wherein said compensating means includes repairing the damaged computer component.

10. The system of claim 1 wherein said insurer requires a fulfillment of at least one prerequisite by the customer to provide compensating means to the customer.

11. The system of claim 10 wherein at least one prerequisite includes installing an anti-virus software program in said computer.

12. A method of insuring a customer having a computer for damage caused by a computer virus, said method comprising the steps of:
offering, by an insurer, coverage of a computer for damage caused by a computer virus to the customer;
selecting, by the customer, coverage offered by the insurer; and
buying, by the customer, offered coverage.

13. The method of insuring a customer of claim 12 further comprising, after the step of buying coverage, the steps of:
infecting the computer by a computer virus;
requesting compensation by the customer for damage caused by the computer virus; and
providing compensation by the insurer to the customer for damage caused by the computer virus.

14. The method of insuring a customer of claim 13 wherein the step of providing compensation to the customer includes repairing the damaged computer.

15. The method of insuring a customer of claim 14 wherein the step of repairing the damaged computer includes repairing computer software installed in the computer.

16. The method of insuring a customer of claim 14 wherein the step of repairing the damaged computer includes repairing a damaged computer component of the computer.

17. The method of insuring a customer of claim 13 wherein the step of providing compensation to the customer includes providing monetary compensation to the customer for damage caused by the computer virus.

18. The method of insuring a customer of claim 13 wherein the step of providing compensation to the customer includes providing a replacement software program to replace damaged installed software caused by the computer virus.

19. The method of insuring a customer of claim 13 wherein the step of providing compensation to the customer includes providing a replacement computer component to replace a damaged computer component caused by the computer virus.

20. The method of insuring a customer of claim 13 wherein the step of providing compensation to the customer includes providing a monetary fee to the customer for lost earnings caused by loss or degradation of performance of the computer.

21. The method of insuring a customer of claim 13 wherein the step of offering coverage to the customer includes requiring the customer to fulfill at least one prerequisite to be covered in the event of damage caused by the computer virus.

22. The method of insuring a customer of claim 21 wherein the step of requiring the customer to fulfill at least one prerequisite includes requiring the installation of an anti-virus software.

23. The method of insuring a customer of claim 21 wherein the step of requiring the customer to fulfill at least one prerequisite includes providing the insurer with a list of programs installed in the computer.

24. A method of insuring a customer having a computer for damage caused by a computer virus, said method comprising the steps of:
offering, by an insurer, coverage of a computer for damage caused by a computer virus to the customer;
selecting, by the customer, coverage offered by the insurer;
buying, by the customer, offered coverage;
infecting the computer by a computer virus;
requiring the customer to fulfill at least one prerequisite to be covered in the event of damage caused by the computer virus;
infecting the computer by a computer virus;
requesting compensation by the customer for damage caused by the computer virus; and
providing compensation by the insurer to the customer for damage caused by the computer virus.
